(19) United States
(12) Patent Application Publication
(10) Pub. No.: US 2012/0250591 A1
(43) Pub. Date: Oct. 4, 2012

(54) METHOD FOR CARRIER AGGREGATION AND METHOD FOR DYNAMIC SPECTRUM ALLOCATION

(75) Inventors: Xinxi Diao, Shenzhen (CN); Xiaodong Zhu, Shenzhen (CN); Zhengrong Lai, Shenzhen (CN); Zhifeng Ma, Shenzhen (CN); Guang Yang, Shenzhen (CN)

(73) Assignee: ZTE CORPORATION, Shenzhen, Guangdong Province (CN)

(21) Appl. No.: 13/509,579

(22) PCT Filed: Jun. 12, 2010
(86) PCT No.: PCT/CN10/73889

§ 371 Date: May 11, 2012

(30) Foreign Application Priority Data
Dec. 31, 2009 (CN) 200910260737.6

(51) Int. Cl. H04W 72/04; H04J 1/00; H04J 3/00

(52) U.S. Cl. 370/280

(57) ABSTRACT

A method for carrier aggregation comprises: in a first time zone, sending, by a radio access point, a downlink signal to a user terminal by using a first guard band between a time division duplexing (TDD) system and a frequency division duplexing (FDD) system and a bidirectional communication band of the TDD system; or/and, in a second time zone, receiving, by the radio access point, a uplink signal sent by the user terminal using a second guard band between the TDD system and the FDD system and the bidirectional communication band. A method for dynamically allocating a spectrum is further provided. By way of the present invention, the utilization rate of the guard band and the flexibility in the use of the guard band are improved.

### CROSS-REFERENCE TO RELATED APPLICATIONS

This application is a U.S. Nationalization of PCT International Application No. PCT/CN2010/073889 filed 12 Jun. 2010, entitled “METHOD FOR CARRIER AGGREGATION AND METHOD FOR DYNAMIC SPECTRUM ALLOCATION”, which claims priority to Chinese Patent Application No. 200910260737.6, filed 31 Dec. 2009, the contents of each of the foregoing applications are incorporated herein, in their entirety, by this reference.

### FIELD OF THE INVENTION

The present invention relates to the field of radio communication, and in particular to a method for carrier aggregation and a method for dynamic spectrum allocation.

### BACKGROUND OF THE INVENTION

Currently, carrier aggregation of the LTE-A (Long Term Evolution Advance) in the 3GPP (Third Generation Partnership Project) not only can achieve a larger transmission bandwidth, but also can achieve a flexible duplex mode. For example, the combined use of the two-way use of the spectrum and the one-way use of the spectrum can be achieved by the carrier aggregation, thereby improving the utilization rate of the spectrum and the flexibility in the use of the spectrum and thereby improving the effectiveness of the radio communications system in use of the spectrum under the complex networking environment.

In order to reduce the network construction cost under the environment of the coexistence of the 2G network system, the 3G network system and the LTE system, the operators construct the network by the RAN Sharing (Radio Access Network Sharing) mode. The RAN Sharing mode is achieved mainly by making the TDD (Time Division Duplexing) system and the FDD (Frequency Division Duplexing) system deploy with co-site or co-antenna.

In the traditional TDD mode, the radio access point adopts the same band to transmit a downlink signal and receive an uplink signal. In order to avoid the interference of receiving and sending signals between the TDD system and the FDD system, it needs to have a band with enough width as a guard band between the TDD system and the FDD system, such as setting the width of the guard band as more than 10 MHz.

Currently, there mainly are two modes for transmitting the signals by using the guard band between the TDD system and the FDD system: mode 1, different station deployment of the micro-cell radio access point, because the indoor radio access point or the micro radio access point and the macro-cell radio access point are deployed in different stations, there is spatial isolation between the micro-cell radio access point and the macro-cell access point; therefore, it only needs to set a smaller guard band between the TDD system and the FDD system (such as setting the guard band as 3 MHz); and mode 2, when the TDD system and the FDD system are deployed with co-site or co-antenna, the micro-cell radio access point or the macro-cell access point uses a guard band between the TDD system and the FDD system to achieve the communication with a user terminal.

Considering the mode that the radio access point uses the guard band between the TDD system and the FDD system to achieve the communication with the user terminal when the TDD system and the FDD system are deployed with co-site or co-antenna, the technical solution provided by the patent application, application No. US20070286156, entitled utilizing guard band between FDD and TDD radio systems, is shown in FIG. 1.

Referring to FIG. 1, it is a schematic diagram of using the guard band spectrum between the TDD system and the FDD system in the technical solution provided by the above patent application (patent No. US20070286156). In FIG. 1, an FDD system which operates within a first band 101 at least provides a first FDD channel; a TDD system which operates within a second band 102 at least provides a first TDD channel; the first band 101 and the second band 102 are separated by a third band 103; and an H-FDD (half-duplex FDD) system which operates within the third band 103 at least provide a first H-FDD channel, with a transmission of the first H-FDD channel being synchronized with an uplink transmission or a downlink transmission of the TDD. The FDD system further at least configures a second FDD channel on a fourth band 104, and the fourth band 104 and the second band 102 are separated by a fifth band 105; and the H-FDD further configures a second H-FDD channel on the fifth band 105. The third band 103 and the fifth band 105 compose a half-duplex FDD (H-FDD).

By adopting the above technical solution, although the utilization rate of the guard band can be partially improved by way of introducing the half-duplex FDD (i.e. HD-FDD) on the guard band, the following defects exist upon introducing the HD-FDD on the guard band: on one hand, when a radio access point sends a downlink signal to a user terminal by using the third band 103, the fifth band 105 is in the idle state, when the radio access point receives an uplink signal sent by the user terminal by using the fifth band 105, the third band 103 is in the idle state, and therefore, the problem that the utilization rate of the guard band is lower exists upon adopting the existing technical solution. On the other hand, it needs two guard bands to guarantee that the band of double-wire-use achieves the normal bidirectional communications, but it cannot guarantee that there is a sufficient bandwidth to ensure the bidirectional communications in the actual network environment, and therefore the problems that the implementation of the bidirectional communications by using the guard band is unstable and the system performance is poor due to the poor flexibility in use of the guard band exist in the related art.

### SUMMARY OF THE INVENTION

The embodiments of the present invention provide a method for carrier aggregation and a method for dynamically allocating a spectrum, so as to improve the spectrum utilization rate of the guard band and the flexibility in the use of the guard band spectrum.

A method for carrier aggregation comprises:

in a first time zone, sending, by a radio access point, a downlink signal to a user terminal by using a first guard band between a TDD system and an FDD system and a bidirectional communication band of the TDD system;

or/and,

in a second time zone, receiving, by the radio access point, a uplink signal sent by the user terminal using a second guard band between the TDD system and the FDD system and the bidirectional communication band.

In the embodiments of the present invention, on one hand, in the TDD system, because the radio access point simultaneously sends the downlink signal to the user terminal by using the bidirectional communication band in the TDD system and the guard band between the TDD system and the FDD system when sending the downlink signal to the user terminal, thereby the spectrum utilization rate of the guard band is improved and the transmission rate of the downlink signal is improved; on the other hand, the user terminal can also simultaneously sends the uplink signal to the radio access point by using the bidirectional communication band in the TDD system and the guard band between the TDD system and the FDD system, thereby further improving the spectrum utilization rate of the guard band and improving the transmission rate of the downlink signal. Therefore, the flexibility of the communications between the radio access point and the user terminal is improved and the flexibility in use of the guard band between the TDD system and the FDD system is also improved by using the technical solution of the present invention.

A method for implementing a dynamic spectrum allocation,

for application in the dynamic spectrum allocation of sharing a guard band between a micro-cell radio access point and a macro-cell radio access point in a TDD system, comprising:

in a first time zone, sending, by the macro-cell access point, a first downlink signal to a user terminal by using a first guard band between the TDD system and an FDD system and a bidirectional communication band of the TDD system;

in a second time zone, sending, by the micro-cell access point, a second downlink signal to the user terminal by using the first guard band between the TDD system and the FDD system and the bidirectional communication band of the TDD system;

or,

in a third time zone, receiving, by the macro-cell radio access point, a first uplink signal sent by the user terminal using a second guard band between the TDD system and the FDD system and the bidirectional communication band;

in a fourth time zone, receiving, by the micro-cell radio access point, a second uplink signal sent by the user terminal using the second guard band between the TDD system and the FDD system and the bidirectional communication band;

the first time zone and the second time zone being respectively a time zone composed of different downlink time slots in the same radio frame;

the third time zone and the fourth time zone being respectively a time zone composed of different uplink time slots in the radio frame; and

adjusting the number of downlink time slots composing the respective time zone and adjusting the number of uplink time slots composing the respective time zone according to the respective downlink traffic of the macro-cell access point and the micro-cell access point.

In the embodiments of the present invention, in the TDD system, when the macro-cell radio access point and the micro-cell radio access point share the guard band between the TDD system and the FDD system, the downlink time slots shared by the macro-cell radio access point and the micro-cell are allocated in the same radio frame structure. And the number of the downlink time slots occupied respectively can be adjusted according to the change of the situation of the downlink service of macro-cell radio access point and the micro-cell radio access point. Thereby it can utilize the spectrum resources more effectively, increase the spectrum utilization rate and improve the network performance.

### BRIEF DESCRIPTION OF THE DRAWINGS

FIG. 1 is a schematic diagram of using the guard band spectrum between the TDD system and the FDD system in the related art;

FIG. 2 is a diagram of spectrum distribution using the TDD system and the FDD system according to the embodiment of the present invention;

FIGS. 3A and 3B are a structural schematic diagram of implementing the downlink carrier aggregation and the uplink carrier aggregation according to the embodiment of the present invention respectively;

FIG. 4 is a first schematic diagram of implementing the asymmetric carrier aggregation on the micro-cell radio access point according to the embodiment of the present invention;

FIG. 5 is a second schematic diagram of implementing the asymmetric carrier aggregation on the micro-cell radio access point according to the embodiment of the present invention;

FIG. 6 is a third schematic diagram of implementing the asymmetric carrier aggregation on the micro-cell radio access point according to the embodiment of the present invention;

FIG. 7 is a schematic diagram of implementing the interference suppression by using the carrier aggregation mode of the present invention according to the embodiment of the present invention;

FIG. 8 is a schematic diagram of using the guard band spectrum by the macro-cell access point according to the embodiment of the present invention;

FIG. 9 is a schematic diagram of using the guard band spectrum by the micro-cell access point according to the embodiment of the present invention; and

FIG. 10 is a schematic diagram of implementing the dynamic spectrum allocation between the macro-cell access point and the micro-cell access point according to the embodiment of the present invention.

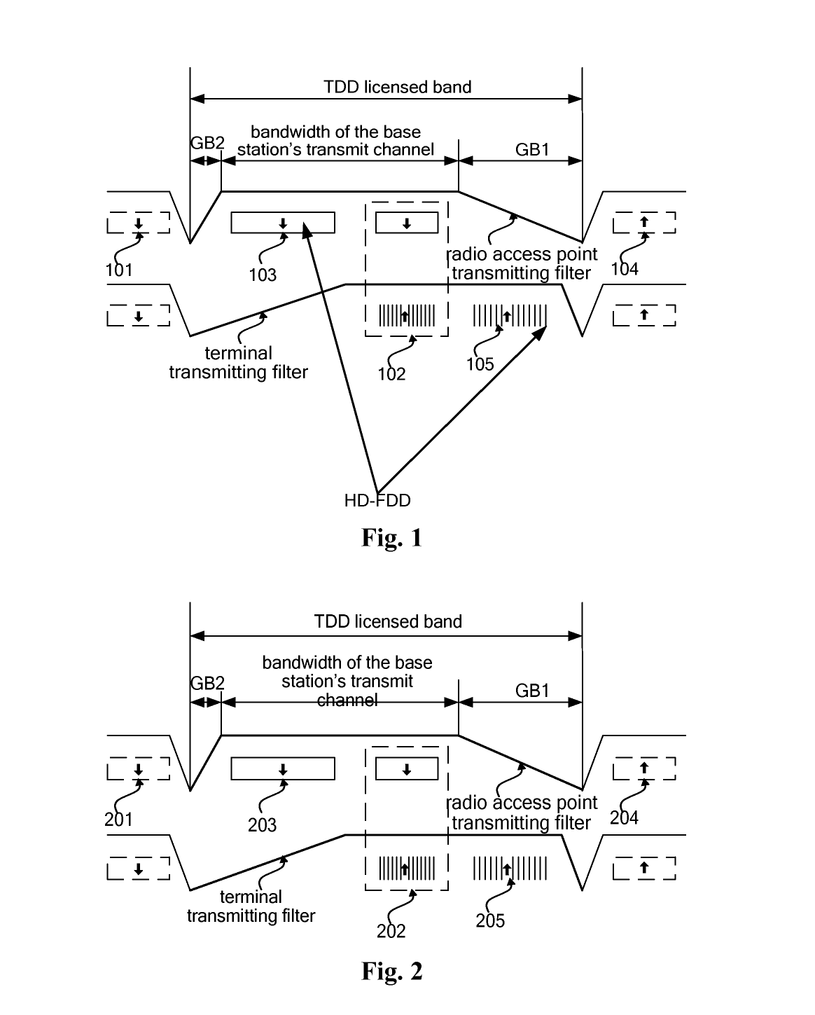

### DETAILED DESCRIPTION OF EMBODIMENTS

The embodiments of the present invention will be described in detail in conjunction with the drawings of the description hereinafter.

Referring to FIG. 2, which is a spectrum distribution diagram of the spectrum of a TDD system and the spectrum of an FDD system in the embodiment of the present invention, the TDD system and the FDD system are deployed with co-site or co-antenna. And the distribution diagram comprises: a first band 201, a second band 202, a third band 203, a fourth band 204 and a fifth band 205, wherein the first band 201 is a downlink band of the paired spectrums in the FDD system; the second band 202 is a band used for bidirectional communication in the TDD system, and the second band 202 is a band used in the traditional TDD mode on the TDD licensed band; the third band 203 is a guard band between the first band 201 and the second band 202; the fourth band 204 is a uplink band of the paired spectrums in the FDD system; and the fifth band 205 is a guard band between the fourth band 204 and the second band 202.

The embodiment of the present invention is not limited to the spectrum distribution diagram as shown in FIG. 2, and can also be a spectrum distribution diagram in which the positions of the first band 201 and the second band 202 are exchanged and the positions of the third band 203 and the fifth band 205 are exchanged.

In the embodiment of the present invention, a macro-cell radio access point operating on the third band 203 and the second band 202 and a macro-cell radio access point operating on the first band 201 or/and a macro-cell radio access point operating on the fourth band 204 are deployed with co-site or co-antenna. Under the circumstance that the station is shared or the antenna is shared between a plurality of macro-cell radio nodes, the size of a guard band (such as the third band 203 and the fifth band 205 in the embodiment of the present invention) between the TDD system and the FDD system needs to be set as more than 10 MHz.

The third band 203 is a sub-band which is located on the TDD frequency band (such as 1880-1920 MHz) in the embodiment of the present invention.

Preferably, in the embodiment of the present invention, the second band 202 and the third band 203 are adjacent or non-adjacent bands on the TDD licensed band. When they are the non-adjacent bands, between the second band 202 and the third band 203, there is (are) band(s) used for one-way communication or bidirectional communication which does not participate in the carrier aggregation.

Preferably, in the embodiment of the present invention, the second band 202 and the fifth band 205 are adjacent or non-adjacent bands on the TDD licensed band. When they are the non-adjacent bands, between the second band 202 and the fifth band 205, there is (are) band(s) used for one-way communication or bidirectional communication which does not participate in the carrier aggregation is comprised.

Preferably, the third band 203 is located between the first band 201 of the FDD system and the second band 202.

Preferably, the fifth band 205 is located between the fourth band 204 of the FDD system and the second band 202.

Preferably, in order to suppress the existence of mutual interference of receiving and sending signals between the third band 203 and the first band 201, in the embodiment of the present invention, an isolation band GB2 is set between the first band 201 and the third band 203 (i.e. the isolation band GB2 is retained at the side adjacent to the first band 201 of the FDD system on the third band 203). Similarly, in the embodiment of the present invention in order to suppress the existence of mutual interference of receiving and sending signals between the fifth band 205 and the fourth band 204, an isolation band GB1 is set between the fifth band 205 and the fourth band 204 (i.e. the isolation band GB1 is retained at the side adjacent to the fourth band 204 of the FDD system on the fifth band 205).

In the embodiment of the present invention, for various types of the radio access point (including the macro-cell radio access point and the micro-cell radio access point), the modes by which they use the guard band between the TDD system and the FDD system are inconsistent. Therefore, the technical solution of the present invention will be described in detail by using two embodiments hereinafter.

### Embodiment 1

Embodiment 1 will be described in detail aiming at the macro-cell radio access point communicating with the user terminal by using the guard band between the TDD system and the FDD system.

In the embodiment of the present invention, the spectrum distribution of the FDD system spectrum and the TDD system spectrum as shown in FIG. 2 is adopted. The macro-cell radio access point sends a synchronization signal and a cell broadcast signal on the second band 202 according to the method specified by the TDD technical standard and provides the spectrum resources for the user terminal accessed randomly according to the mode specified by the TDD technical standard.

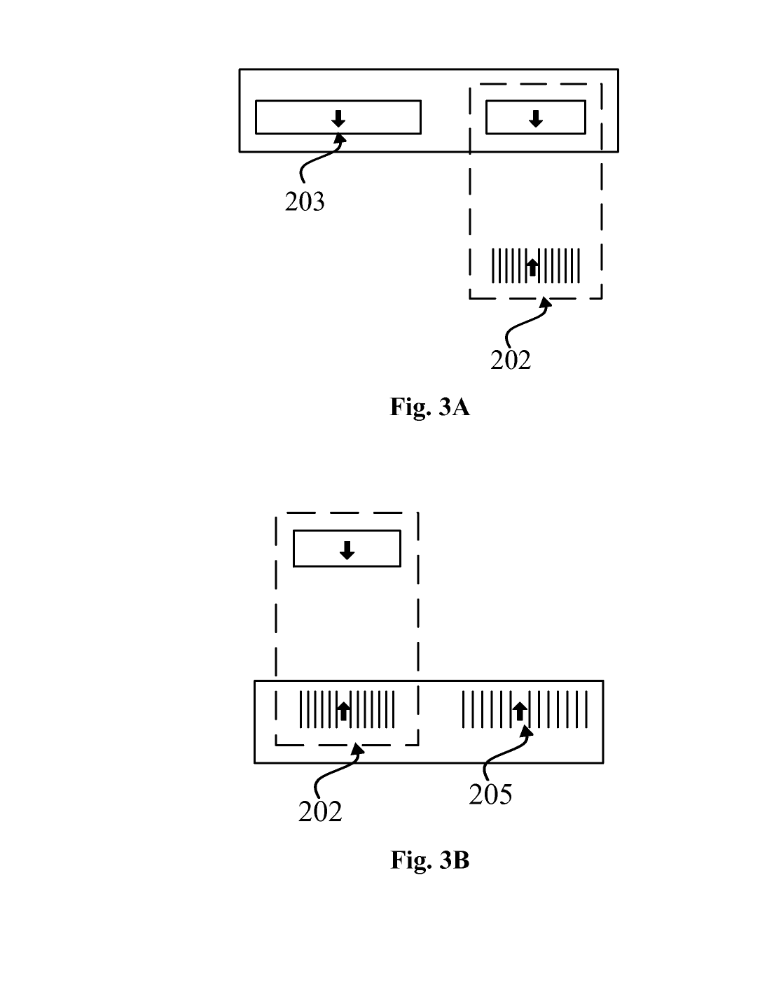

In the TDD system, when the macro-cell radio access point in the TDD system needs to send a downlink signal to the user terminal, in a first time zone (the first time zone is a time zone composed of downlink time slots allocated for the macro-cell radio access point in a radio frame), the macro-cell radio access point sends the downlink signal to the user terminal by using a downlink carrier on the third band 203 and a downlink carrier on the second band 202 parallelly, as shown in FIG. 3A. After having received the downlink signal send by the macro-cell radio access point, the user sends receipt acknowledgement information (such as ACK (Acknowledgement Character) or NACK etc.) to the macro-cell radio access point by using a uplink carrier on the second band 202 in a second time zone (the second time zone is a time zone composed of uplink time slots allocated for the macro-cell radio access point in the radio frame), as shown in FIG. 3B.

When the macro-cell radio access point needs to send a uplink scheduling instruction to the user terminal to instruct the user terminal send a uplink signal to the macro-cell radio access point by using the uplink carrier on the second band 202 and a uplink carrier on the fifth band 205 parallelly, in a third time zone, the macro-cell radio access point sends the uplink scheduling instruction to the user terminal by using the downlink carrier on the second band 202. After having received the uplink scheduling instruction sent by the macro-cell radio access point, the user terminal sends the uplink signal to the macro-cell radio access point by using the uplink carrier on the second band 202 and the uplink carrier on the fifth band 205 parallelly in a fourth time zone.

### Embodiment 2

Embodiment 2 will be described in detail aiming at the micro-cell radio access point communicating with the user terminal by using the guard band between the TDD system and the FDD system.

In the embodiment of the present invention, the spectrum distribution of the FDD system spectrum and the TDD system spectrum as shown in FIG. 2 is adopted.

The micro-cell radio access point using the guard band between the TDD system and the FDD system mainly comprises three modes as follows.

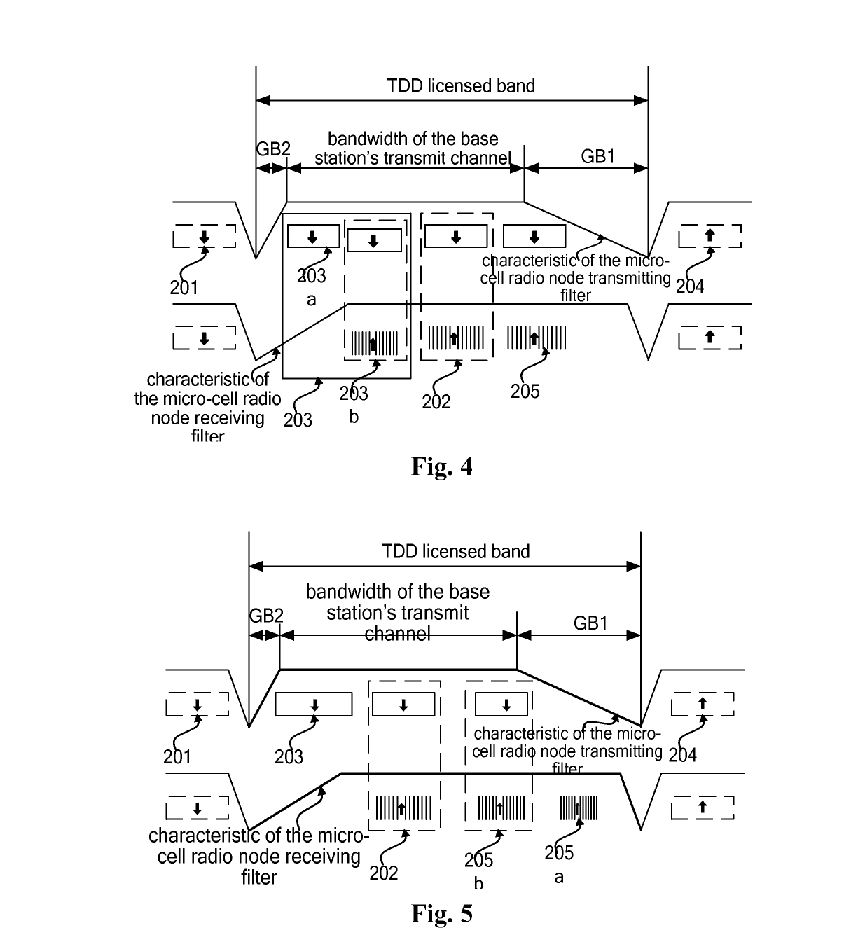

Mode 1: because the micro-cell radio access point and the macro-cell radio access point in the TDD system/FDD system are deployed in different stations, therefore, due to the effect of the spatial isolation the interference intensity of the transmit power of the macro-cell radio access point disposed on the first band 201 which has been received by the micro-cell radio access point disposed on the third band 203 is lower. Thus, the micro-cell radio access point can receive the uplink signal sent by the user terminal by using a part of the band in the third band 203. As shown in FIG. 4, the third band 203 can be divided into a first sub-band (which is represented by 203a hereinafter) and a second sub-band (which is represented by 203b hereinafter), wherein the first sub-band 203a is used for one-way downlink communication; and the second sub-band 203b is used for bidirectional communication. The size of the band of the first sub-band 203a is determined by the interference produced by the uplink signal transmitted by the TDD user terminal on the second sub-band 203b on the downlink signal received by the FDD user terminal on the first band 201. For example, the size of the first sub-band 203a is set to ensure that when the TDD user terminal of the first sub-band 203a transmits the uplink signal to the micro-cell radio access point, the signal power which is leaked by it to the FDD user terminal of the first band 201 is lower than a preset power threshold.

The implementation of the communications between the micro-cell radio access point and the user terminal by using the above mode 1 is as follows: when the micro-cell radio access point needs to send a downlink signal to the user terminal, the micro-cell radio access point sends the downlink signal (the downlink signal comprises one or more of the following signals: a cell broadcast signal of the macro-cell, a multimedia broadcast signal of the macro-cell, a cell synchronization signal and service data of the macro-cell) to the user terminal by using a downlink carrier of the second band 202 and a downlink carrier of the first sub-band 203a or/and a downlink carrier of the second sub-band 203b in a first time zone. After the user terminal has received the downlink signal sent by the micro-cell radio access point, the user terminal sends the ACK or the NACK to the micro-cell radio access point by using a uplink carrier of the second band 202 or/and a uplink carrier of the second sub-band 203b in a second time zone.

Mode 2: because the micro-cell radio access point and the macro-cell radio access point in the TDD system/FDD system are deployed in different stations, therefore, due to the effect of the spatial isolation the interference intensity of the micro-cell radio access point disposed on the fifth band 205 on the macro-cell radio access point disposed on the fourth band 204 is lower. Thus, the micro-cell radio access point can send the downlink signal to the user terminal by using a part of the band in the fifth band 205. As shown in FIG. 5, the fifth band 205 can be divided into a third sub-band (which is represented by 205a hereinafter) and a fourth sub-band (which is represented by 205b hereinafter), wherein the third sub-band 205a is used for one-way uplink communication; and the fourth sub-band 205b is used for bidirectional communication. The size of the band of the third sub-band 205a is determined by the interference produced by the uplink signal transmitted by the FDD user terminal on the fourth band 204 on the downlink signal received by the TDD user terminal on the fourth sub-band 205b. For example, the size of the third sub-band 205a is set to ensure that when the FDD user terminal of the fourth band 204 transmits the uplink signal to the macro-cell radio access point, the signal power which is leaked by it to the TDD user terminal of the fourth sub-band 205b is lower than a preset power threshold.

The implementation of the communications between the micro-cell radio access point and the user terminal by using the above mode 2 is as follows: when the micro-cell radio access point needs to send a uplink scheduling instruction to the user terminal, the micro-cell radio access point can send the uplink scheduling instruction to the user terminal by using a downlink carrier of the second band 202 or/and a downlink carrier of the fourth sub-band 205b in a third time zone (the third time zone is a time zone composed of downlink time slots which are allocated by a radio frame for the micro-cell radio access point). After having received the uplink scheduling instruction sent by the micro-cell radio access point, the user terminal parallelly sends a uplink signal to the micro-cell radio access point by using a uplink carrier of the second band 202 and a uplink carrier of the fourth sub-band 205b or/and a uplink carrier of the third sub-band 205a in a fourth time zone (the fourth time zone is a time zone composed of uplink time slots which are allocated by the radio frame for the micro-cell radio access point).

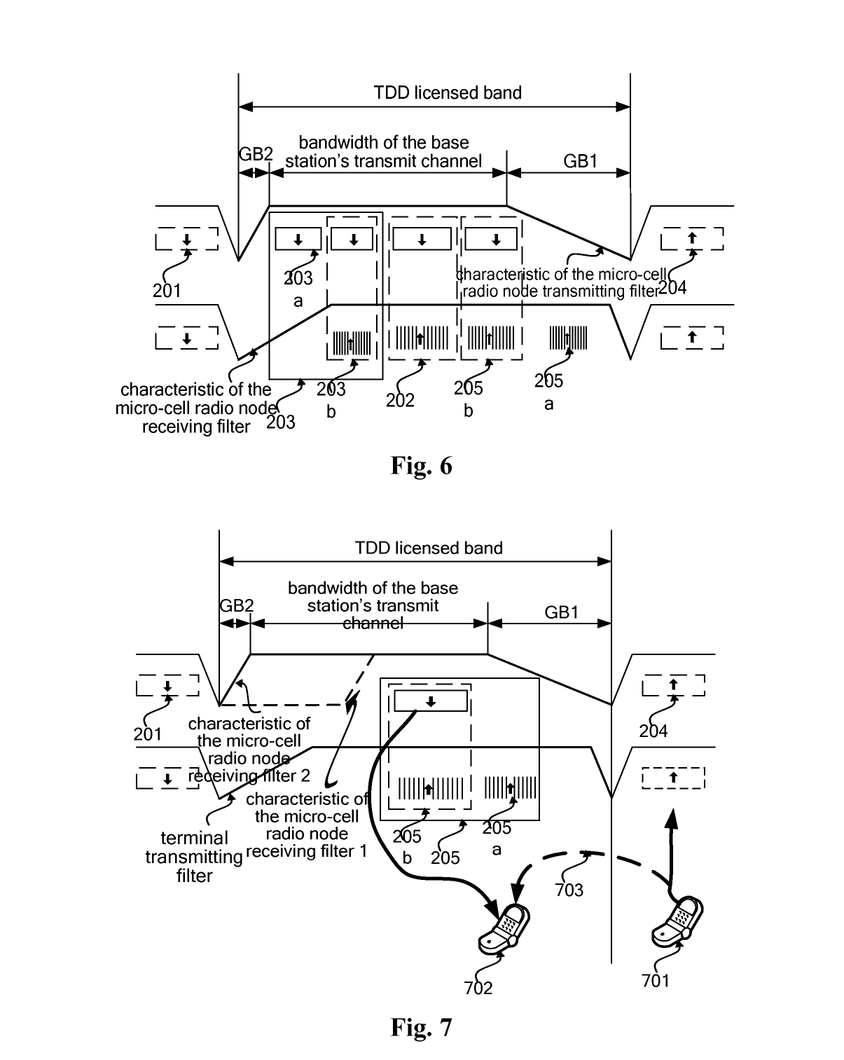

Mode 3: in order to further sufficiently use the third band 203 and the fifth band 205 to implement bidirectional communication, the micro-cell radio node can communicate with the user terminal by using the fifth band 205, the third band 203 and the second band 202. As shown in FIG. 6, the above mode 1 is adopted on the third band 203 and the second band 202 to implement the communications with the user terminal, and the above mode 2 is adopted on the fifth band 205 and the second band 202 to implement the communications with the user terminal.

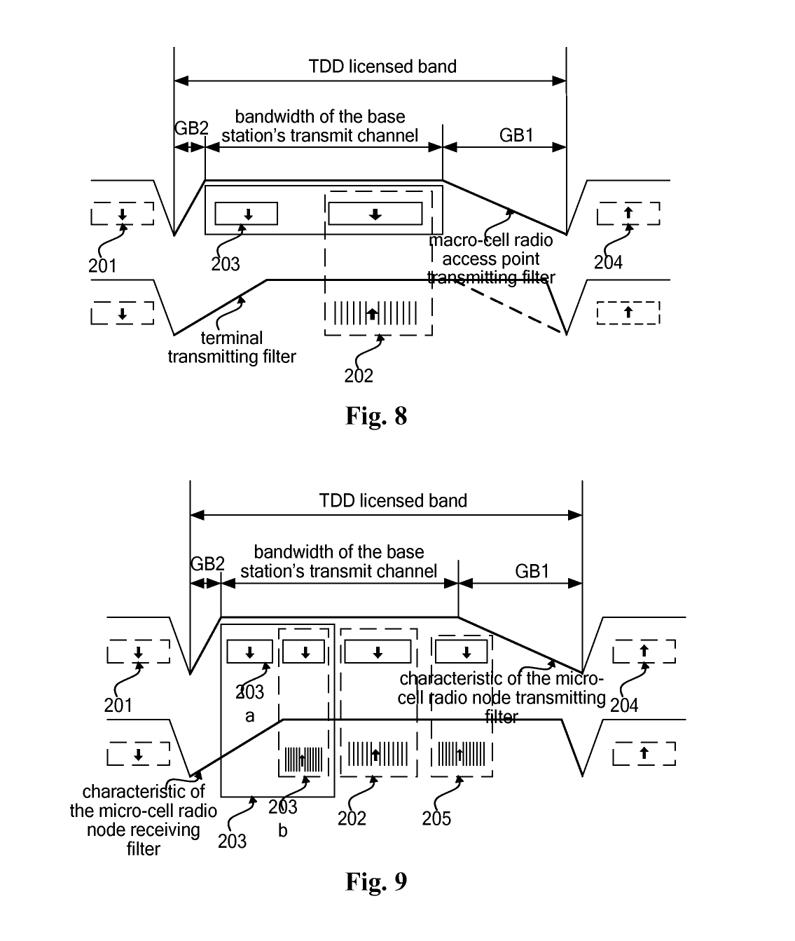

Preferably, in order to control the interference produced by the signal transmitted by the FDD user terminal on the fourth band 204 on the signal received by the TDD user terminal on the fifth band 205 within an acceptable range, in the embodiment of the present invention, a reception channel of the micro-cell radio access point is set on the fourth sub-band 205b (i.e. the third sub-band 205a is set between the fourth sub-band 205b and the fourth band 204, and the third sub-band 205a is adopted to serve as a guard band between the fourth sub-band 205b and the fourth band 204). As shown in FIG. 7, if the total bandwidth of the fifth band 205 is 10 MHz, the bandwidth of the fourth sub-band 205b is set to be 5 MHz. Similarly, in order to control the interference produced by the signal transmitted by the TDD user terminal on the third band 203 on the signal received by the FDD user terminal on the first band 201 within an acceptable range, in the embodiment of the present invention, a reception channel of the micro-cell radio access point is set on the second sub-band 203b (i.e. the first sub-band 203a is set between the second sub-band 203b and the first band 201, and the first sub-band 203a is adopted to serve as a guard band between the second sub-band 203b and the first band 201). As shown in FIG. 8, if the total bandwidth of the third band 203 is 10 MHz, the bandwidth of the second sub-band 203b is set to be 5 MHz.

Preferably, in order to suppress the interference produced by the uplink signal transmitted by the TDD user terminal located on the second sub-band 203b to the micro-cell radio access point in the TDD system on the signal received by the FDD user terminal located on the first band 201 in the FDD system, in the embodiment of the present invention, the reception channel of the micro-cell radio access point is set on the second sub-band 203b (i.e. the first sub-band 203a is located between the second sub-band 203b and the first ban 201 of the FDD system, and the first sub-band 203a is the guard band between the second sub-band 203b and the first band 201 of the FDD system, as shown in FIG. 9).

It needs to be noted that the reason that receiving the signal on the fifth band can be implemented by using the technical solution of the present invention can be explained by an example, and the example is as follows: in the embodiment of the present invention, the interference between the fourth band 204 and the fifth band 205 mainly is the interference produced by the signal transmitted by the FDD terminal on the fourth band 204 to the FDD system radio access point on the signal sent from the radio access point and received by the TDD terminal on the fifth band 205. As shown in FIG. 7, when an FDD terminal 701 operating on the fourth band 204 sends a uplink signal to the radio access point of the FDD system, an outward leaked signal 703 carried thereby may be received by a TDD terminal 702 which currently is in the receiving state. Because the fourth sub-band 205b and the fourth band 204 are separated by the third sub-band 205a (the size of the third sub-band 205a is about 5 MHz generally), and due to the limitation of the ACLR (Adjacent Channel Leakage Ratio), the power of the leaked signal 703 from the FDD terminal to the TDD terminal is more than 40 dB lower than the transmit power of the FDD terminal. And because the transmit power of the micro-cell radio access point is greater than or equal to the transmit power of the FDD terminal, the path loss from the micro-cell radio access point to the TDD terminal 702 is equivalent to the path loss from the FDD terminal 701 to the TDD terminal 702. Therefore, even if the path loss from the micro-cell radio access point to the TDD terminal 702 is 30 dB greater than the path loss from the FDD terminal 701 to the TDD terminal 702, under the circumstance that the transmit power of the micro-cell radio access point is identical to that of the FDD terminal 701, the power which is received by the TDD terminal from the micro-cell radio access point is 10 dB greater than the power which is leaked by the FDD terminal 701 to the TDD terminal 702. Therefore, it can be guaranteed that the TDD terminal receives normally the signals on the fifth band by using the technical solution of the present invention.

The mode for aggregating the carriers provided by the embodiment of the present invention can be applied in the TDD system and can also be applied in a collaborative system composed of the FDD system and the TDD system.

In the embodiments of the present invention, for one aspect, in the TDD system, because the radio access point simultaneously sends the downlink signal to the user terminal by using the bidirectional communication band in the TDD system and the guard band between the TDD system and the FDD system when sending the downlink signal to the user terminal, thereby the spectrum utilization rate of the guard band is improved and the transmission rate of the downlink signal is improved. For another aspect, the user terminal can also simultaneously sends the uplink signal to the radio access point by using the bidirectional communication band in the TDD system and the guard band between the TDD system and the FDD system, thereby further improving the spectrum utilization rate of the guard band and improving the transmission rate of the downlink signal. For yet another aspect, aiming at the macro-cell radio access point and the micro-cell radio access point, the guard band and a different band is aggregated to implement the communications with the user terminal, therefore, the flexibility of the communications between the radio access point and the user terminal is improved. And the flexibility in use of the guard band between the TDD system and the FDD system is also improved by using the technical solution of the present invention.

Based on the above mode which the macro-cell radio access point and the micro-cell radio access point use a guard band between the TDD system and the FDD system, the embodiment of the present invention further provides a method for dynamically allocating spectrum resources between the macro-cell and the micro-cell, and the method is applied in the dynamic spectrum allocation of sharing a guard band between a micro-cell radio access point and a macro-cell radio access point in a TDD system.

In the embodiment of the present invention, how the macro-cell radio access point adopts a guard band between the TDD system and an FDD system to implement the communications with a user terminal can adopt the mode in embodiment 1; and how the micro-cell radio access point adopts the guard band between the TDD system and the FDD system to implement the communications with the user terminal can adopt the mode in embodiment 2, which will not be described here redundantly.

In the embodiment of the present invention, radio frames used by the macro-cell radio access point and the micro-cell radio access point keeps strict synchronization in time slots allocation, and the downlink time slots configuration of the time division duplexing radio frame by the macro-cell radio access point on the third band 203 and the second band 202 is strictly consistent with the downlink time slots configuration of the radio frame by the micro-cell radio node on the second sub-band 203b.

In the present embodiment, the micro-cell radio node operating on the second sub-band 203b is an indoor distributing base station and the macro-cell radio node is an outdoor distributing base station. Because the micro-cell radio access point and the macro-cell radio access point are deployed in different stations, a very large spatial isolation exists between the micro-cell radio access point and the macro-cell radio access point. If the spatial isolation between the micro-cell radio access point and the macro-cell radio access point is greater than 40 dB, the backhaul path (BACKHAULL) of the micro-cell radio access point can adopt the mode of XDSL (Digital Subscriber Line) or XPON (Passive Optical Network) to implement.

In the embodiment of the present invention, the synchronization between the downlink time slots configuration of the time division duplexing radio frame adopted by the macro-cell radio access point and the time slots of the radio frame adopted by the micro-cell radio access point can be implemented by one of the following modes or the combination thereof:

mode 1: it is implemented by a synchronization signal which meets the IEEE 1588 standard and on the XDSL and the XPON; and

mode 2: it is implemented by receiving a synchronization signal sent by the macro-cell radio access point on the second band 202 or the third band 203.

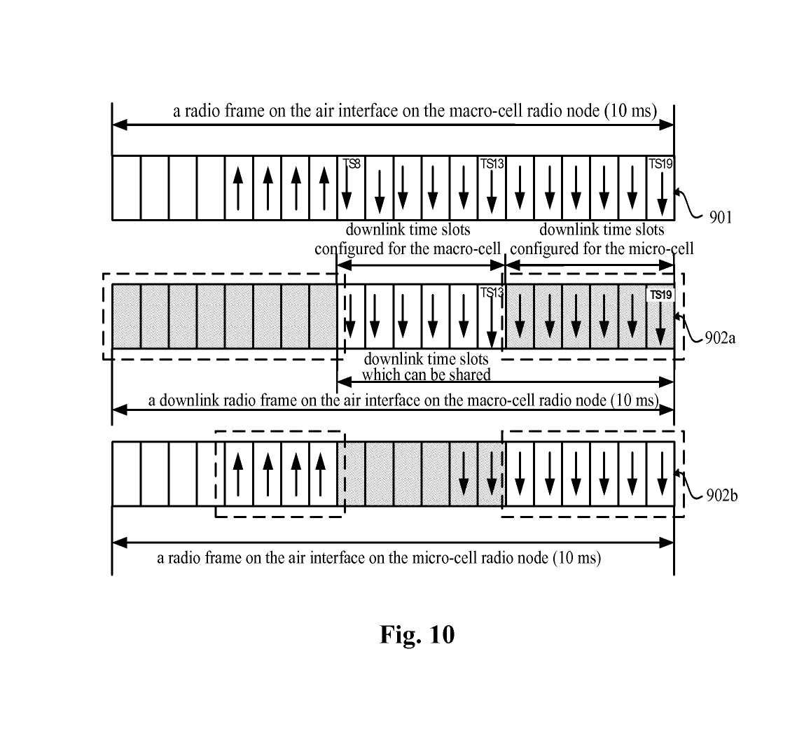

In the present embodiment, the micro-cell radio access point and the macro-cell radio access point share the third band 203 to implement the dynamic spectrum allocation between the micro-cell radio access point and the macro-cell radio access point, which can be illustrated by FIG. 10.

The time division duplexing radio frame 901 adopted by the macro-cell radio node operating on the second band 202 is a radio frame having the structure that meets the LTD TDD specification; and the radio frame 902a adopted by the macro-cell radio node operating on the third band 203 is a radio frame having the structure which only has the downlink time slots, and the radio frame 902a can have the structure of a downlink radio frame of the FDD, and can also have the structure of an LTE TDD radio frame served as the downlink time slots.

The radio frame 902a adopted by the micro-cell radio access point operating on the second sub-band 203b is a radio frame having the structure which only has the downlink time slots, and the radio frame 902a is strictly synchronous with the radio frame 901. And the downlink time slots configuration in the radio frame structure 902a is identical to the downlink time slots configuration in the radio frame on the second sub-band 203b.

A radio frame 902b adopted by the micro-cell radio access point operating on the second sub-band 203b is a radio frame having the structure that meets the LTD TDD specification, and the downlink slots which can be shared by the macro-cell radio access point and the micro-cell radio access point are contained in the radio frame structure. And the downlink time slots which can be shared can be dynamically allocated to the macro-cell radio access point and the micro-cell radio access point according to the downlink traffic of the macro-cell radio access point and the micro-cell radio access point and in accordance with the various proportions. As shown in FIG. 10, the TS8-TS19 in the radio frame are the downlink time slots that can be shared by the macro-cell radio access point and the micro-cell radio access point, in which TS8-TS13 are allocated to the macro-cell radio access point to send the downlink signal and the TS13-TS19 are allocated to the micro-cell radio access point to send the downlink signal. The number of the downlink time slots occupied respectively can be adjusted dynamically according to the change of the situation of the downlink traffic of macro-cell radio access point and the micro-cell radio access point. For example, when the downlink traffic of the macro-cell radio access point is larger, the time slots TS8-TS17 can be allocated to the macro-cell radio access point to send the downlink signal and the time slots TS18-TS19 can be allocated to the micro-cell radio access point to send the downlink signal.

In the embodiments of the present invention, in the TDD system, when the macro-cell radio access point and the micro-cell radio access point share the guard band between the TDD system and the FDD system, the downlink time slots shared by the macro-cell radio access point and the micro-cell are allocated in the same radio frame structure. And the number of the downlink time slots occupied respectively can be adjusted according to the change of the situation of the downlink service of macro-cell radio access point and the micro-cell radio access point. Therefore, it can utilize the spectrum resources more effectively, increase the spectrum utilization rate and improve the network performance.

Preferably, in the embodiment of the present invention, the macro-cell radio access point can send the downlink signal to the user terminal by using the single-carrier or multi-carrier on the guard band. For example, the macro-cell radio access point sends the downlink signal to the user terminal by using a carrier on the second sub-band 203b or the first sub-band 203a, or the macro-cell radio access point sends the downlink signal to the user terminal by using a carrier on the first sub-band 203a and the second sub-band 203b. The macro-cell radio access point sends the downlink signal to the user terminal by using a carrier on the second sub-band 203b and the first sub-band 203a respectively. Similarly, the macro-cell radio access point can also receive the uplink signal sent by the user terminal by way of the single-carrier or multi-carrier. For example, the macro-cell radio access point receives the uplink signal sent by the user terminal using a carrier on the second sub-band 203b or the first sub-band 203a, or the macro-cell radio access point receives the uplink signal sent by the user terminal using a carrier on the first sub-band 203a and the second sub-band 203b. The macro-cell radio access point receives the uplink signal sent by the user terminal using a carrier on the second sub-band 203b and the first sub-band 203a respectively.

By using the technical solution of the present invention, for one aspect, the uplink and downlink asymmetric spectrum aggregation are introduced into the guard band between the TDD system and the FDD system and the TDD system's band in the TDD system, thereby improving the flexibility for utilizing the guard band between the TDD system and the FDD system in the TDD system. For another aspect, for the micro-cell radio access point, by introducing the uplink and downlink asymmetric spectrum aggregation on the guard band between the TDD system and the FDD system, bidirectional communication of the micro-cell radio access point on the guard band have been implemented and the mutual interference existing in the receiving and sending the signal between the TDD user terminal carrying out bidirectional communication on the guard band and the FDD terminal on the adjacent bands has been suppressed. For yet another aspect, the flexibility and the effectiveness using the guard band is improved by the flexible configuration of the micro-cell radio access point and the macro-cell radio access point (the macro-cell radio access point is an access point in the TDD system) in the use of the spectrum.

Obviously, various alterations and changes to the present invention are apparent to those skilled in the art without leaving the spirit and scope of the present invention. As such, if these alterations and changes to the present invention belong within the scope of claims of the present invention and the equivalent technology, the present invention is also intended to comprise these alterations and changes.

1. A method for carrier aggregation, being applied for a time division duplexing (TDD) system or a collaborative system composed of a TDD system and a frequency division duplexing (FDD) system, and comprising:
in a first time zone, sending, by a radio access point, a downlink signal to a user terminal by using a first guard band between the TDD system and the FDD system and a bidirectional communication band of the TDD system,
or/and,
in a second time zone, receiving, by the radio access point, an uplink signal sent by the user terminal using a second guard band between the TDD system and the FDD system and the bidirectional communication band.

2. (canceled)

3. The method according to claim 1, wherein the first guard band is located between a downlink band of the FDD system and the bidirectional communication band; and
the second guard band is located between a uplink band of the FDD system and the bidirectional communication band.

4. The method according to claim 3, wherein a first isolation band is further retained at the side adjacent to the downlink band of the FDD system on the first guard band; and
a second isolation band is further retained at the side adjacent to the uplink band of the FDD system on the second guard band.

5. The method according to claim 1, wherein the radio access point is a micro-cell radio access point;
the first guard band comprises a first sub-band used for one-way communication and a second sub-band used for bidirectional communication; and
the step of sending, by the radio access point, the downlink signal to the user terminal comprises:
using, by the radio access point, the first sub-band or/and the second sub-band of the first guard band, and the bidirectional communication band to send the downlink signal to the user terminal.

6. The method according to claim 5, after the radio access point sends the downlink signal to the user terminal, further comprising:
in the second time zone, receiving, by the radio access point, a second uplink signal sent by the user terminal using the second sub-band of the first guard band or/and the bidirectional communication band.

7. The method according to claim 5, wherein the second sub-band is located between the first sub-band and the bidirectional communication band.

8. The method according to claim 1, wherein the radio access point is a micro-cell radio access point;
the second guard band comprises a third sub-band used for one-way communication and a fourth sub-band used for bidirectional communication; and
the step of receiving, by the radio access point, the uplink signal sent by the user terminal comprises:
receiving, by the radio access point, the uplink signal which is sent by the user terminal to the micro-cell radio access point using the third sub-band or/and the fourth sub-band of the second guard band and the bidirectional communication band.

9. The method according to claim 8, before the radio access point receives the uplink signal sent by the user terminal, further comprising:
in the first time zone, sending, by the radio access point, a second downlink signal to the user terminal using the fourth sub-band of the second guard band or/and the bidirectional communication band.

10. The method according to claim 8, wherein the fourth sub-band is located between the third sub-band and the bidirectional communication band.

11. A method for implementing a dynamic spectrum allocation, being applied for the dynamic spectrum allocation of sharing a guard band between a micro-cell radio access point and a macro-cell radio access point in a time division duplexing (TDD) system, and comprising:
in a first time zone, sending, by the macro-cell access point, a first downlink signal to a user terminal by using a first guard band between the TDD system and a frequency division duplexing (FDD) system and a bidirectional communication band of the TDD system;
in a second time zone, sending, by the micro-cell access point, a second downlink signal to the user terminal by using the first guard band between the TDD system and the FDD system and the bidirectional communication band of the TDD system;
or,
in a third time zone, receiving, by the macro-cell radio access point, a first uplink signal sent by the user terminal using a second guard band between the TDD system and the FDD system and the bidirectional communication band;
in a fourth time zone, receiving, by the micro-cell radio access point, a second uplink signal sent by the user terminal using the second guard band between the TDD system and the FDD system and the bidirectional communication band;
the first time zone and the second time zone being respectively a time zone composed of different downlink time slots in the same radio frame;
the third time zone and the fourth time zone being respectively a time zone composed of different uplink time slots in the radio frame; and
adjusting the number of downlink time slots composing the respective time zone and adjusting the number of uplink time slots composing the respective time zone according to the downlink traffic of the macro-cell access point and the micro-cell access point.

12. The method according to claim 11, wherein the first guard band comprises a first sub-band used for one-way communication and a second sub-band used for bidirectional communication; and
in the first time zone, sending, by the macro-cell access point, the first downlink signal to the user equipment by using the first guard band comprises the steps of:
sending, by the macro-cell radio access point, the first downlink signal to the user equipment on the second sub-band or/and the first sub-band by using a downlink carrier;
or, sending, by the macro-cell radio access point, the first downlink signal to the user equipment by using two downlink carriers, wherein one downlink carrier of the two downlink carriers is sent through the second sub-band, and the other downlink carrier is sent through the first sub-band.

13. The method according to claim 11, wherein the second downlink signal is one or more of the following signals: a multimedia broadcast signal, a cell synchronization signal, service data, and a cell information broadcast signal of the macro-cell radio access point.

14. The method according to claim 1, wherein the first guard band and the second guard band are guard bands between a TDD macro-cell and a FDD macro-cell deployed with co-site or co-antenna.

15. The method according to claim 6, wherein the second sub-band is located between the first sub-band and the bidirectional communication band.

16. The method according to claim 9, wherein the fourth sub-band is located between the third sub-band and the bidirectional communication band.

17. The method according to claim 12, wherein the second downlink signal is one or more of the following signals: a multimedia broadcast signal, a cell synchronization signal, service data, and a cell information broadcast signal of the macro-cell radio access point.
